(19) United States
(12) Patent Application Publication
(10) Pub. No.: US 2008/0033953 A1
(43) Pub. Date: Feb. 7, 2008

(54) METHOD TO SEARCH TRANSACTIONAL WEB PAGES

(75) Inventors: Shivakumar Vaithyanathan, San Jose, CA (US); Rajasekar Krishnamurthy, Sunnyvale, CA (US); Yunyao Li, Ann Arbor, MI (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,806

(22) Filed: Aug. 7, 2006

(51) Int. Cl. G06F 17/30

(52) U.S. Cl. 707/9

(57) ABSTRACT

A method of performing transactional web page searches is disclosed. The method includes examining a plurality of web pages, identifying transactional features within a set of the plurality of web pages, and classifying the set of web pages as transactional. The method proceeds with annotating and indexing the transactional web pages, and, in response to a user-designated transactional query, providing only the set of web pages that have been classified as transactional. The identifying transactional features comprises checking for the existence of positive patterns and verifying the absence of negative patterns with respect to a set of contents within each of the plurality of web pages and comprises identifying transactional actions to be performed and identifying transactional objects of the transactional actions to be performed. The annotating and indexing the transactional features comprises annotating and indexing transactional actions and transactional objects.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to searching web pages, and particularly to searching transactional web pages.

2. Description of Background

Most user searches of web pages, such as an intranet or extranet, for example, may be divided into one of three types: a navigational search, where the goal is to reach a specific website address, an informational search, where the intent is to locate information from one or more web pages, and a transactional search, with the intent to perform some web-mediated activity, such as to download a software program, or to obtain a form, for example. Because most web pages are informational (and not transactional), typical web page search engines perform well for informational and navigational searches, however they do not support transactional queries well. Given a set of keywords, there are likely to be many more non-transactional pages that include the given keywords than actual transactional pages. For example, while a query within a group of web pages to seek a specific “property damage report” form using the keywords “property damage report” may have as a target one specific web page, it may return many links that discuss property damage, which may be specific to different departments within an intranet, but fail to provide a link to the desired form near the top of the results. While it may be possible to navigate to the desired form from the pages provided by the top returned links, the path may not be obvious.

Accordingly, the state of the art will be advanced by a method that overcomes these drawbacks.

### SUMMARY OF THE INVENTION

The shortcomings of the prior art are overcome and additional advantages are provided through the provision of a method to identify web pages that are transactional, and to allow a user to perform a search among only those web pages that have been so identified.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which allows a user to search transactional web pages. A transactional search allows the user to quickly perform the desired action without the need to examine many web pages lacking the desired transactional content.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a processing unit in accordance with an embodiment of the invention.

FIG. 2 illustrates one example of an algorithm template for a transaction annotator in accordance with an embodiment of the invention.

FIG. 3 illustrates one example of an algorithm to identify transactional objects in accordance with an embodiment of the invention.

FIG. 4 illustrates one example of an algorithm to identify transactional actions in accordance with an embodiment of the invention.

FIG. 5 illustrates one example of simplified patterns of regular expressions and gazetteers for download transactions in accordance with an embodiment of the invention.

FIG. 6 illustrates one example of simplified patterns of regular expressions and gazetteers for form entry transactions in accordance with an embodiment of the invention.

FIGS. 7 through 10 illustrate enhancement in transactional query performance in accordance with embodiments of the invention.

FIG. 11 illustrates an exemplary flowchart of method to perform transactional queries in accordance with embodiments of the invention.

The detailed description explains the preferred embodiments of the invention, together with advantages and features, by way of example with reference to the drawings.

### DETAILED DESCRIPTION OF THE INVENTION

An embodiment of the invention will identify a set of web pages that contain transactional content, thereby allowing only such pages to be returned in response to a user-designated transactional search query. In an embodiment of the invention, information can be identified regarding the nature of the transaction supported by the page, and terms that are associated with the transaction.

Traditional information retrieval (IR) includes a preparatory phase, during which documents are inserted into a collection, and indices are created or updated. Traditional IR also includes an operational phase, during which search queries are efficiently evaluated. In an embodiment of the invention, additional work is performed in the preparatory phase for transactional queries. Specifically, web pages that are likely to be relevant to transactional queries are identified and annotated with the set of transactions and transactional features, such as the web page title, name of the software program to be downloaded, links to downloadable software, or other information on the web page, for example. Such web pages shall also be referred to herein as transactional pages. The set of all transactional pages is a subset of the complete document, or web page, collection. These transactional pages can then be processed in different ways (as will be described further below) to create a transactional collection for search by a user.

The recognition of transactional pages is performed by a transactional annotator, configured to identify all transactions supported by a given web page. In an embodiment, a templatized procedure, that is, a procedure that utilizes templates, is configured to increase the precision of the transactional annotator to identify web pages that act as gateways to forms and applications.

In an embodiment, the transactional annotator serves two purposes: First, to classify each web-page as being either transactional or not; and Second, to return those specific sections that support the transactions. As used herein, the term transactional feature shall represent those sections of the web page that support transactions. In an embodiment, a highly optimized, purpose-designed, rule-based classifier is used to provide the relevant portions of the web page. In an exemplary embodiment, the transaction annotator will focus on two common classes of transactions: software downloads (SD) and form-entry (FE).

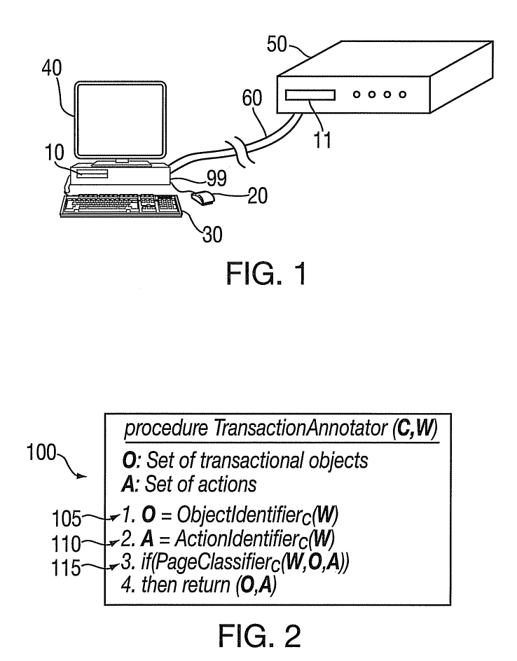

Turning now to the drawings in greater detail, it will be seen that FIG. 1 depicts an embodiment of an exemplary processing unit 99 in data communication with a program storage device 10. The processing unit 99 may be in data communication with input devices, such as a mouse 20 and a keyboard 30, for example, and an output device, such as a display screen 40. An additional program storage device 11 may be located within a server 50 in signal communication with the processing unit 99 via a network 60 or wireless communication. In an embodiment, the processing unit 99 is utilized to perform a user-designated transactional search of web pages that have been classified and stored on the server 50.

While an embodiment has been depicted with a server connected to a processing unit, and data stored upon a program storage device at either the processing unit or the server, it will be appreciated that the scope of the invention is not so limited, and that the invention will also apply to alternate arrangements of processing units and servers, such as having many processing units in data communication with one server, many processing devices in data communication with many servers, and many processing devices in connection with many servers, which are also connected to other servers, for example. While an embodiment has been depicted with a processing unit in data communication with a server via a wired network, it will be appreciated that the scope of the invention is not so limited, and that the invention will also apply to other methods of data communication, such as wireless connection networks, for example.

Referring now to FIG. 2, an algorithm template 100 for the transaction annotator is depicted. A first 105 and second 110 step identify the transactional features. Specifically, the first step 105 is to identify transactional objects, and the second step 110 is to identify transactional actions. The transactional object is the object of the transaction, such as the name of a software program to be downloaded, or an actual form to be downloaded, for example. The transactional action is the action to be performed, such as the downloading of downloadable links, for example. Both steps 105, 110 rely primarily on checking for the presence of positive patterns and verifying the absence of negative patterns. In an embodiment, positive pattern matches are carefully constructed regular expression patterns and gazetteer lookups, while negative pattern matches are regular expressions based on the gazetteer. A regular expression is a string that describes or matches a set of strings, according to certain syntax rules. An example of a regular expression may be a search for a sequence of characters not more than five characters long, followed by a sequence of numbers not more than three numbers long. The regular expression will also incorporate rules to define how to react to combinations and permutations of the search, such as finding that advancing the search window by one character changes the result of the search. An exemplary gazeeteer is a dictionary, or a list of entries. An example of gazeeteer entries may include a specific list of known software names, or other specific strings of text, for example. In an embodiment, different regular expressions and gazeeteers may be utilized for different sections of the web page, such as for the title and a candidate, or possible, transactional feature, for example.

The presence of the positive pattern is a finding by the regular expression of strings that match the certain syntax rules, or specific strings, on the web page that are likely to indicate the presence of the transactional feature. However, the presence of the negative pattern is a finding by the regular expression of strings that match certain syntax rules, or specific strings, on the web page that are likely to indicate the absence of the transactional feature. Accordingly, in an embodiment, web pages that have positive pattern matches and lack negative pattern matches are most likely to include transactional features.

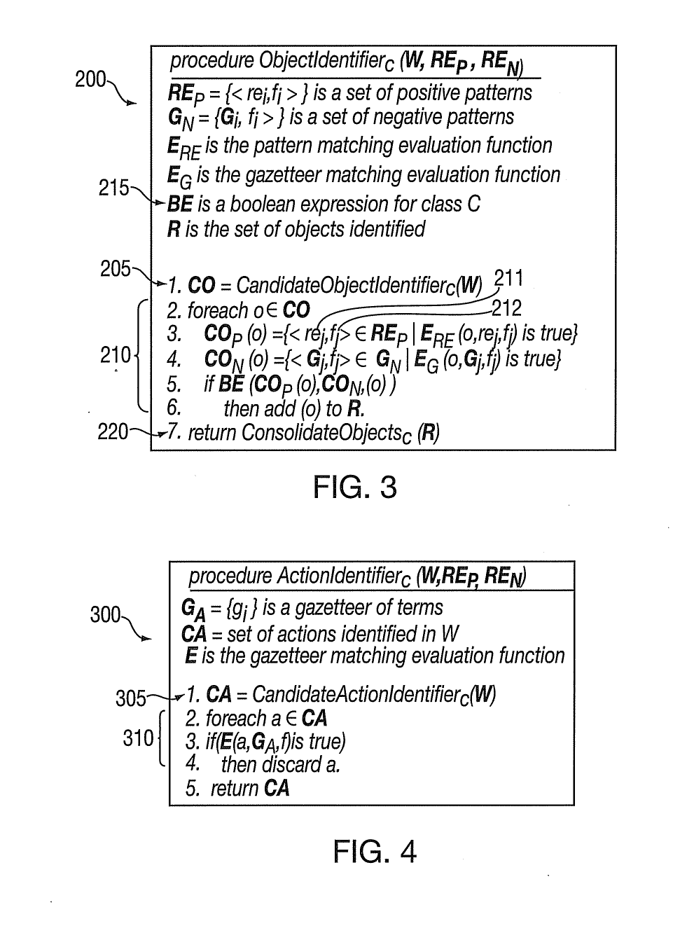

Referring now to FIG. 3, an exemplary embodiment of an algorithm 200 to identify transactional objects 105 is depicted. In an embodiment configured to identify SD transactions, for example, candidate software names are extracted in step 205 by looking for patterns resembling software names with version numbers, such as “Software Name—Version 1.0” It will be appreciated that “Software Name” may refer to any specified known software program, as well as any unknown text string that may or may not included the word “Version”, followed by a numeric string to generally indicate a revision of the software program, for example. Some returns will be false positives, such as “Chapter 1.1”. For each candidate object, the algorithm 200 evaluates 205 patterns comprising features in the portions of the web page that are pertinent to the candidate object that is being evaluated. Each pattern comprises a regular expression (re) 211 and a feature (f) 212. For example, for SD the only feature of interest is the object text, that is, the text that describes the software name, such as “Software Name” or “Chapter”, for example. As an example, one positive pattern for object text requires that the first letter be capitalized. It is important to note that complex transactions (such as FE, for example) contain a richer set of features. False positives, such as “Chapter 1.1”, for example, will be pruned as a negative pattern using entries contained within the gazetteer. A Boolean expression (BE) 215, over this set of positive and negative pattern matches, decides whether the candidate object is relevant. Finally, consolidating the relevant objects recognized on each web page of the set of web pages and, returning them by ConsolidateObjects 220. For example, candidate objects, such as “Software Manufacturer Software Name” and “Software Name”, as in the case where the name of the software manufacturer may optionally be included within the name of the name of the software program, for example, will be consolidated into a single object.

Referring now to FIG. 4, an exemplary embodiment of an algorithm 300 to identify transactional actions 110 is depicted. The algorithm 300 begins with identifying 305 several candidate actions. With several regular expressions and gazetteer lookups the candidate list is pruned 310.

Referring back now to FIG. 2, a PageClassifier classifies 115 webpages based on the transaction objects and transaction actions on each web page. In an embodiment, any web page that contains at least one transactional object and at least one transactional action associated with the transaction object is classified as a transactional page.

In an embodiment, identifying transactional features (also known as feature engineering) and defining regular-expressions and gazetteers is accomplished using a manual iterative process, such as using intranet data, for example. There is an interaction between the choice of features and regular expressions/gazetteers. In an embodiment, the final set of features includes hyperlinks, anchor-texts and html tags along with more specific features such as a window of text around candidate objects and actions.

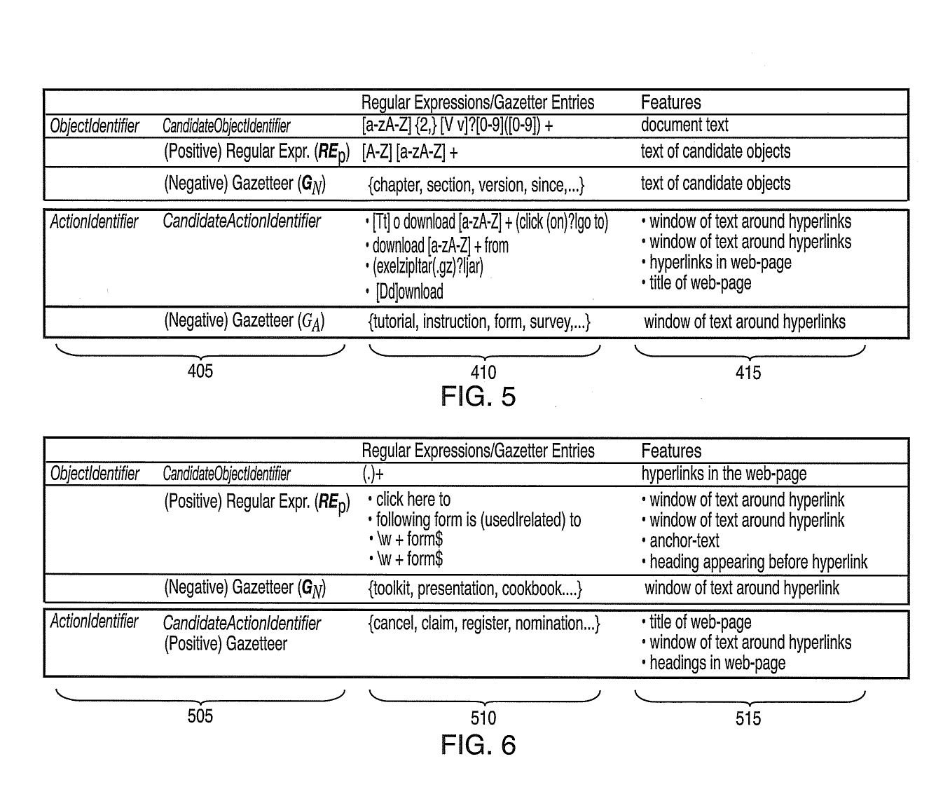

Referring now to FIG. 5, several simplified versions of example patterns of regular expressions and gazetteers used by the algorithm template 100 to identify transactional features for, or associated with, SD are depicted. Similarly, FIG. 6 depicts example patterns used by the algorithm template 100 to identify transactional features for, or associated with, FE. The first two columns 405, 505 describe where in the algorithm 100, 200, 300 the patterns are used, the third columns 410, 510 list some example regular expressions or gazetteer entries, and the fourth columns 415, 515 list the feature on which the regular expression or gazetteer is evaluated. For example, in the first row of an embodiment as depicted in FIG. 5, an example pattern to identify candidate transaction objects is shown. The regular expression is evaluated over the document text.

While an embodiment of the invention has been described with simplified versions of example patterns of regular expressions and gazetteers used by the algorithm template 100 to identify transactional features for SD and FE, it will be appreciated that the scope of the invention is not so limited, and that the invention will also apply to regular expressions and gazetteers that are configured to identify transactional features associated with other classes of transactions, such as making a purchase, filing a property damage claim, and making travel reservations, for example.

The result of the algorithm template 100 for the transactional annotator described above is a set of transactional pages, each with an associated set of transactional features. Subsequent processing ultimately provides a transactional collection that is indexed by the search engine.

In an embodiment, at the collection level, document filtering can require that each transactional page include at least one transactional object. Accordingly, only pages meeting this requirement would be available to a query indicated by the user as a transactional query.

In another embodiment, term filtering, within the web page, is utilized to retain only those portions of the web page that have been identified as containing transactional features. Each transactional page is likely to contain many terms, only a small number of which are actually associated with the transaction. In an embodiment of term filtering, only those terms that appear in the transactional features will be indexed, to be made readily available for a search engine in response to a subsequent, user-designated transactional query.

In an alternate embodiment, synonym expansion, with respect to each transactional term, is performed. Transactional queries typically have a general form of <action><object>, such as “download program”, for example. In many cases, the action has multiple synonyms and there is the possibility of a mismatch between the term appearing in the user query and that appearing in the web-page, such as “obtain”, rather than “download” some software package, for example. The object, on the other hand, being associated with the name of an entity, such as a trademark for example, is less likely to be confused by the user. In an embodiment, this potential mismatch within the web pages that have been classified as transactional is addressed by expanding the annotation of the transactional features to include synonyms of the transactional features. Note that performing synonym expansion over the entire web page collection will dramatically increase the size of the index. In an embodiment, expanding only the transactional actions to include synonyms of the transactional actions in the transactional collection will mitigate this increase in index size, yet still enhance the performance of the transactional query.

Following is a description of experimental results of an evaluation of the foregoing method. A collection of textual intranet web pages with a small set of Multipurpose Internet Mail Extensions (MIME) types, such as html, and php, for example, within a research university domain were recursively collected. The web page collection included 434,211 web pages with a total size of 6.49 gigabytes (GB).

A set of 15 transactional search tasks were derived from an informal survey conducted among administrative staff and graduate students in the research university. Ten of the tasks are to find particular forms, and five are to download software. A total of 394 unique queries to perform these tasks were developed by a group of 26 students and recently graduated students.

Apache Lucene™, a high-performance, full-featured text search engine (available from http://lucene.apache.org/java/docs/) was used to index and search the four following data collections. The original data set, comprising 434,211 web pages as described above is referred to as S-DOC. An embodiment of document filtering, as described above, based on the existence of transactional objects within the S-DOC data set, with each document classified as being a transactional page or not, will be referred to as S-TDC. A separate index was created for the collection of transactional pages within S-TDC, even though this collection is a strict subset of the pages in S-DOC. S-ANT-NE (defined as an embodiment of term filtering, as described above) is a collection created by writing all of the transaction features (for both SD and FE) on the same document into a single file. The identifier associated with each file is the original document. S-ANT is an embodiment of a collection generated similar to S-ANT-NE, but also including a term-level synonym expansion. WordNet™ (available from http://www.wordnet.princeton.edu) was used as a general thesaurus to expand the verbs in the transactional features. While an embodiment of the invention has been described using the Apache Lucene™ text search engine and the WordNet™ thesaurus, it will be appreciated that they are for illustration only, and that scope of the invention is not so limited, and will also include the use of other text search engines and thesauruses.

In the case of a transactional query, it is most often the case that the user is only interested in one way to perform the transaction. That is, the user is likely to care the most about the top ranked relevant match returned. Accordingly, results of most experiments are reported in terms of the mean reciprocal rank (MRR) measure. For each unique query of each task, the reciprocal value (1/n) of the rank (n) of the highest ranked correct result is obtained. This value is averaged over all the queries corresponding to the same task. The reciprocal rank of a query is set to 0 if no correct result is found in the first 100 pages returned.

Correct answers are considered to be those web pages that can support the desired transaction task. For example, a correct answer for “download Remedy Client” must be a web page from which the software “Remedy Client” can be downloaded directly. As such, there is little subjectivity in determining relevance.

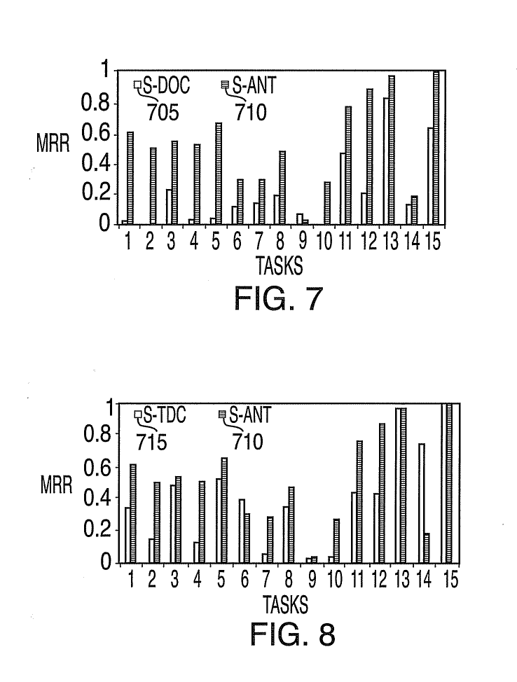

Referring now to FIG. 7, the MRR is depicted on the y-axis for each task, depicted along the x-axis, over S-DOC 705 and S-ANT 710. It will be appreciated that the search based on S-ANT 710 almost always outperforms that based on S-DOC 705. For nearly two-thirds of the tasks, S-ANT 710 achieves higher than 0.5 in the MRR, while S-DOC 705 only achieves similar performance for 3 of them. In particular, for five of the tasks, S-DOC 705 failed to return any correct answer in the top 20 results, while S-ANT 710 on average returned a correct answer in the top two results for the same tasks.

Referring flow to FIG. 8, the MRR is depicted on the y-axis for each task, depicted along the x-axis, over S-TDC 715 and S-ANT 710. This chart compares the effectiveness of transactional collection as generated via term filtering to document filtering. The results of the study between S-ANT 710 (term filtering) and S-TDC 715 (document filtering) indicate that S-ANT 710 performs better than S-TDC 715 in 13 out of 15 tasks. This implies that extracting transactional features is generally adequate for the transactional search, and that obtaining extra content from unrelated content may actually harm search performance.

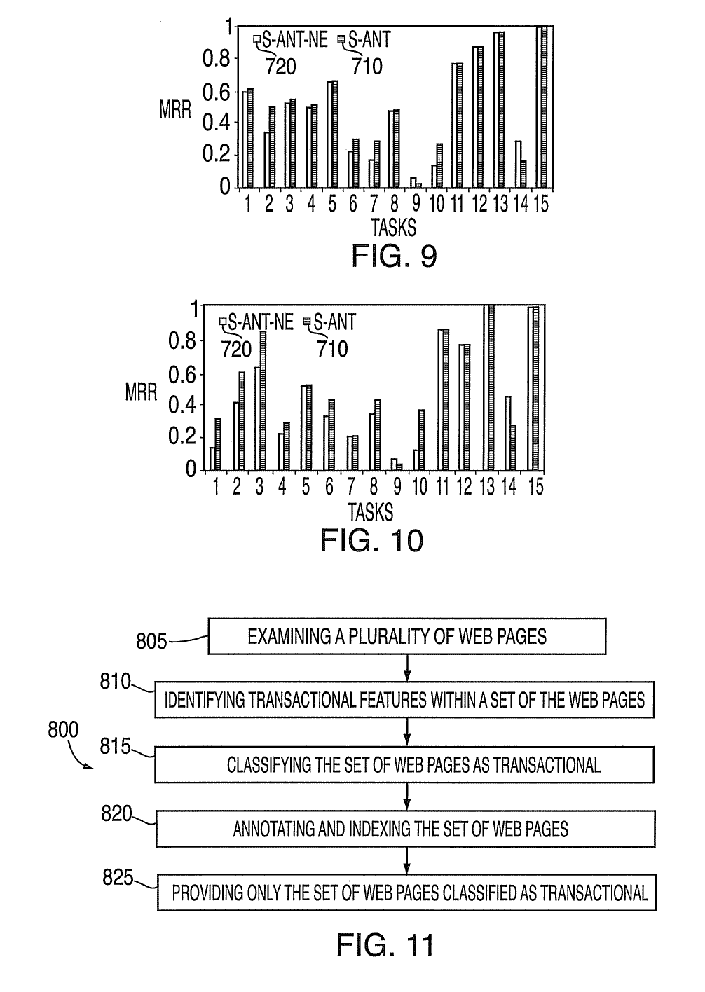

Referring now to FIG. 9 and FIG. 10, the MRR is depicted on the y-axis for each task, depicted along the x-axis, over S-ANT-NE 720 and S-ANT 710. These charts compare the effectiveness of embodiments of transactional synonym expansion. FIG. 9 depicts the improvement of MRR by synonym expansion on verbs appearing in all queries. It will be appreciated that synonym expansion of the verbs in all queries provides marginal improvement. FIG. 10 depicts the improvement of MRR by synonym expansion only in those queries containing verbs. It will be appreciated from comparison of the charts depicted in FIGS. 9 and 10 that the advantage of synonym expansion is enhanced in response to its application to queries that contain verbs.

Referring now to FIG. 11, a flow chart 800 of an exemplary embodiment of a method performing transactional web page searches is depicted. The method begins with examining 805 a plurality of web pages, identifying 810 transactional features within a set of the plurality of web pages, and in response to identifying that the set of web pages comprise transactional features, classifying 815 the set of web pages as transactional. In an embodiment, the examining 805 the plurality of web pages comprises examining a plurality of intranet web pages.

The method continues by annotating and indexing, according to the transactional features, the set of transactional web pages to increase an accuracy of a set of results of a user-designated transactional query, and in response to the user-designated transactional query, providing 825 to the user only the set of web pages that have been classified as transactional, and meet the appropriate query criteria. In an embodiment, the identifying 810 transactional features includes checking for the existence of positive patterns and verifying the absence of negative patterns with respect to a set of contents within each of the plurality of web pages. In an embodiment, the identifying 810 transactional features includes identifying 810 transactional actions to be performed by the transactional feature, and additionally identifying transactional objects of the actions to be performed. In an embodiment, the annotating and indexing 820 the transactional features comprises annotating and indexing transactional actions and transactional objects.

In an embodiment, the identifying 810 the transactional features comprises identifying transactional objects associated with at least one of: software program names; and an actual form to be downloaded. In an embodiment, the identifying 810 the transactional features comprises identifying transactional actions associated with at least one of: making a property damage claim; downloading software; making travel reservations; and online form entry. The above examples are for illustration, and not limitation.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of performing transactional web page searches comprising:
examining a plurality of web pages;
identifying transactional features within a set of the plurality of web pages;
in response to identifying that the set of web pages comprise transactional features, classifying the set of web pages as transactional;
annotating and indexing, according to the transactional features, the set of transactional web pages to increase an accuracy of a set of results of a user-designated transactional query; and
in response to the user-designated transactional query, providing only the set of web pages that have been classified as transactional;
wherein the identifying transactional features comprises checking for the existence of positive patterns and verifying the absence of negative patterns with respect to a set of contents within each of the plurality of web pages;
wherein the identifying transactional features comprises identifying transactional actions to be performed and identifying transactional objects of the transactional actions to be performed; and
wherein the annotating and indexing the transactional features comprises annotating and indexing transactional actions and transactional objects.

2. The method of claim 1, wherein:
the examining the plurality of web pages comprises examining a plurality of intranet web pages.

3. The method of claim 1, wherein:
the identifying transactional features within the set of web pages comprises identifying at least one transactional action associated with at least one transactional object present on each web page of the set of web pages.

4. The method of claim 1, wherein:
the identifying transactional features comprise identifying transactional features associated with making a purchase.

5. The method of claim 1, wherein:
the identifying transactional features comprise identifying transactional features associated with filing a property damage claim.

6. The method of claim 1, wherein:
the identifying transactional features comprises identifying transactional features associated with downloading software.

7. The method of claim 1, wherein:
the identifying transactional features comprises identifying transactional features associated with making travel reservations.

8. The method of claim 1, wherein:
the identifying transactional features comprises identifying transactional features associated with online form entry.

9. The method of claim 1, wherein:
the identifying transactional features comprises identifying transactional features associated with software program names.

10. The method of claim 1, wherein:
the identifying transactional features comprises identifying transactional features associated with an actual form to be downloaded.

11. The method of claim 1, further comprising:
consolidating the transactional objects identified on each web page of the set of web pages.

12. The method of claim 1, further comprising:
expanding the annotation of the transactional features to include synonyms of the transactional features.

13. The method of claim 12, wherein:
the expanding the annotation of the transactional features comprises expanding only the transactional actions to include synonyms of the transactional actions.

14. A program storage device readable by a machine, the device embodying a program or instructions executable by the machine to perform the method of claim 1.
